(19) United States
(12) Patent Application Publication
(10) Pub. No.: US 2013/0269662 A1
(43) Pub. Date: Oct. 17, 2013

(54) METHOD AND DEVICE FOR MONITORING ERRORS IN AN EXHAUST GAS RECIRCULATION SYSTEM

(71) Applicants: Daniel KUHN, Walddorfhaeslach (DE); Andras MONTVAY, Markgroeningen (DE); Wilhelm BLUMENDELLER, Freiberg (DE); Julian REICHEL, Ditzingen (DE)

(72) Inventors: Daniel KUHN, Walddorfhaeslach (DE); Andras MONTVAY, Markgroeningen (DE); Wilhelm BLUMENDELLER, Freiberg (DE); Julian REICHEL, Ditzingen (DE)

(73) Assignee: Robert Bosch GmbH, Stuttgart (DE)

(21) Appl. No.: 13/846,463

(22) Filed: Mar. 18, 2013

(30) Foreign Application Priority Data
Mar. 26, 2012 (DE) 102012204756.5

(51) Int. Cl. F02M 25/07

(52) U.S. Cl. CPC F02M 25/07
USPC 123/568.11

(57) ABSTRACT

A method and device for monitoring errors in an exhaust gas recirculation line, including supplying an engine with fresh air via a supply duct using a compressor, discharging exhaust gas via an exhaust duct using a gas turbine, a subflow of the gas being supplied from a low-pressure area of the exhaust duct downstream from the turbine, via the recirculation line, to an intake air low-pressure area of the supply duct upstream from the compressor, an exhaust gas mass flow of the subflow in the recirculation line is set via a valve, a fresh air mass flow being set by a fresh air throttle, or via an exhaust flap in the exhaust duct. Where the fresh air throttle or the exhaust flap is opened when the recirculation line is free of errors, an error in the recirculation line is deduced if the throttle or flap is at least partially closed.

### RELATED APPLICATION INFORMATION

The present application claims priority to and the benefit of German patent application no. 10 2012 204 756.5, which was filed in Germany on Mar. 26, 2012, the disclosure of which is incorporated herein by reference.

### FIELD OF THE INVENTION

The present invention relates to a method for monitoring errors in a low-pressure exhaust gas recirculation line of an internal combustion engine, the internal combustion engine being supplied with fresh air via an air supply duct with the aid of a compressor of a turbocharger, exhaust gas of the internal combustion engine being discharged via an exhaust duct with the aid of an exhaust gas turbine of the turbocharger, a subflow of the exhaust gas being supplied from an exhaust gas low-pressure area of the exhaust duct downstream from the exhaust gas turbine of the turbocharger, via the low-pressure exhaust gas recirculation line, to an intake air low-pressure area of the air supply duct upstream from the compressor of the turbocharger, an exhaust gas mass flow of the subflow of the exhaust gas in the low-pressure exhaust gas recirculation line being set via a low-pressure exhaust gas recirculation valve, a fresh air mass flow being set by a fresh air throttle provided in the air supply duct, or an exhaust gas mass flow being set via an exhaust flap provided in the exhaust duct. Moreover, the present invention relates to a device for monitoring errors in a low-pressure exhaust gas recirculation line of an internal combustion engine, an air supply duct being provided with a compressor of a turbocharger for supplying fresh air to the internal combustion engine, an exhaust duct being provided with an exhaust gas turbine of the turbocharger for discharging exhaust gas of the internal combustion engine, the low-pressure exhaust gas recirculation line being provided downstream from the exhaust gas turbine of the turbocharger for withdrawing a subflow of the exhaust gas from an exhaust gas low-pressure area of the exhaust duct and for supplying the subflow of the exhaust gas to an intake air low-pressure area of the air supply duct upstream from the compressor of the turbocharger, a low-pressure exhaust gas recirculation valve being provided in the low-pressure exhaust gas recirculation line for setting an exhaust gas mass flow of the subflow of the exhaust gas, a fresh air throttle being provided in the air supply duct for setting a fresh air mass flow, or an exhaust flap being provided in the exhaust duct for setting an exhaust gas mass flow.

### BACKGROUND INFORMATION

For compliance with exhaust gas emissions regulations for internal combustion engines, it is known to add a portion of the exhaust gas to the intake air of the internal combustion engine via a so-called exhaust gas recirculation system. In this regard, high-pressure systems are known in which the exhaust gas is withdrawn and supplied near the internal combustion engine, and low-pressure exhaust gas recirculation lines are known in which the exhaust gas is withdrawn after flowing through an exhaust gas turbine and an oxidation catalytic converter and/or a particle filter, and is admixed into the intake air branch upstream from a compressor.

German patent document DE 102010027976 A1 discusses a method for operating an internal combustion engine, the internal combustion engine having a supply system for supplying an air mixture to the internal combustion engine, in the supply direction the supply system having in succession a first section having a comparatively low pressure, a compressor for compressing the supplied air mixture, and a second section having a comparatively high pressure, the internal combustion engine having an exhaust system for discharging exhaust gas from the internal combustion engine, the exhaust system having a section which has a comparatively low pressure of the exhaust gas, and the internal combustion engine having an exhaust gas recirculation system which recirculates into the first section of the air supply duct at least a portion of the exhaust gas which flows through the section of the exhaust system having the comparatively low pressure, the recirculated portion of the exhaust gas and supplied fresh air forming the air mixture which flows through the supply system.

In a low-pressure exhaust gas recirculation line, an exhaust gas filter (emergency filter) which protects the downstream components, in particular the compressor, from particles is necessary. Such particles may arise, for example, when a diesel particle filter has a rupture, or when particles are dislodged from the surface in the new state of the filter. The filter may be made of nonwoven fabric or a close-meshed grid. If such a filter becomes plugged during operation, the mass flow rate of recirculated exhaust gas decreases, and [emission] limits may be exceeded. For this reason, it is a requirement to diagnose plugging of the filter (see CARB [regulations], for example).

### SUMMARY OF THE INVENTION

Therefore, it is an object of the exemplary embodiments and/or exemplary methods of the present invention to provide a method for diagnosing a plugged exhaust gas filter or a reduced cross section in the low-pressure branch of an exhaust gas recirculation system.

Moreover, it is an object of the exemplary embodiments and/or exemplary methods of the present invention to provide a device for carrying out the method.

The object of the exemplary embodiments and/or exemplary methods of the present invention relating to the method may be achieved in that, in operating points of the internal combustion engine in which the fresh air throttle or the exhaust flap is opened when the low-pressure exhaust gas recirculation line is free of errors, an error in the low-pressure exhaust gas recirculation is deduced if the fresh air throttle or the exhaust flap is at least partially closed. If the internal combustion engine is in an operating state, such as in partial load operation, in which the fresh air throttle or the exhaust flap is opened when all components operate properly, a reduction in the mass flow in the low-pressure exhaust gas recirculation line results in a reduced differential pressure across the low-pressure exhaust gas recirculation valve. An associated control system recognizes this reduced mass flow and opens the low-pressure exhaust gas recirculation valve in order to increase the mass flow and thus increase the exhaust gas quantity added to the fresh air, so that the prescribed emission limits for the internal combustion engine are maintained. A reduced mass flow in the low-pressure exhaust gas recirculation line may occur if an exhaust gas filter situated at that location is clogged, or if the cross section of the low-pressure exhaust gas recirculation line is reduced in some other way. If the low-pressure exhaust gas recirculation valve is completely open, the control system, depending on the overall system design, closes the fresh air throttle or the exhaust flap in order to reduce the intake air or to increase the exhaust gas pressure, and thus bring the mixing ratio of the fresh air to recirculated exhaust gas in the intake air to the intended value. In both cases, the closing of the fresh air throttle or of the exhaust flap is an indication of a faulty state of the low-pressure exhaust gas recirculation line, which according to the exemplary embodiments and/or exemplary methods of the present invention is recognized and reported.

In one specific embodiment of the present invention, for assessing whether the fresh air throttle or the exhaust flap is at least partially closed, a pressure difference or a pressure ratio across the fresh air throttle or the exhaust flap, or a flap position of the fresh air throttle or of the exhaust flap, is evaluated. Based on the pressure values upstream and downstream from the fresh air throttle, the difference or the ratio of the pressures may be formed and assessed. The pressure upstream from the exhaust flap may be formed in a ratio with the external pressure, or the difference between the two pressures is formed for assessing the position of the exhaust flap.

In another specific embodiment, an error in the low-pressure exhaust gas recirculation line is deduced if a certain pressure difference in the flow direction in the air supply duct or of the exhaust duct, or a certain pressure ratio in the flow direction, is greater than a predetermined threshold value, or an error in the low-pressure exhaust gas recirculation line is deduced if a certain pressure difference opposite to the flow direction in the air supply duct or of the exhaust duct, or a certain pressure ratio opposite to the flow direction, is less than a predetermined threshold value, or if the flap position of the fresh air throttle or of the exhaust flap is further closed in the actuating direction than a predetermined threshold value.

If the threshold value is predefined as a function of the operating conditions of the internal combustion engine, a particularly clear-cut distinction may be made between an intact exhaust gas recirculation system and a mass flow that is reduced due to an error state.

If the checking of the error condition begins only after the operating conditions of the internal combustion engine in which the fresh air throttle or the exhaust flap is open have been present for at least a predefined enable time and/or the threshold value condition has been met for a predefined minimum period, allowable states which are present for a brief time may be recognized within the scope of a debouncing strategy via the enable time and via averaging of the differential pressure or of the position of the fresh air throttle or of the exhaust flap, and erroneous error displays may be reduced.

Increasing clogging of the exhaust gas filter may be recognized by deducing an error condition for an insufficient or a restricted exhaust gas mass flow in the low-pressure exhaust gas recirculation line by comparison with various predefinable threshold values. A trend may thus be recognized early, if necessary, without an error already being present.

The object of the exemplary embodiments and/or exemplary methods of the present invention relating to the device may be achieved in that, for monitoring errors, a control device having a unit for generating an error display is provided, and in operating points of the internal combustion engine in which the fresh air throttle or the exhaust flap is open when the low-pressure exhaust gas recirculation line is free of errors, the unit outputs the error display when the fresh air throttle or the exhaust flap is at least partially closed. With the aid of the device according to the present invention, a reduction in the mass flow in the low-pressure exhaust gas recirculation line may be reliably recognized and reported as an error in accordance with exhaust emission regulations, such as CARB regulations.

If an exhaust gas filter for removing particles from the subflow of the exhaust gas is provided in the low-pressure exhaust gas recirculation line, and the error monitoring is provided for displaying an impermissibly reduced subflow of the exhaust gas through the low-pressure exhaust gas recirculation line, a reduced exhaust gas recirculation, for example due to a clogged exhaust gas filter, may be recognized.

The exemplary embodiments and/or exemplary methods of the present invention are explained in greater detail below with reference to one exemplary embodiment illustrated in the figures.

### BRIEF DESCRIPTION OF THE DRAWINGS

FIG. 1 shows a schematic illustration of an internal combustion engine having an exhaust aftertreatment system and a fresh air supply duct.

FIG. 2 shows a diagram of pressure differences across a fresh air throttle.

### DETAILED DESCRIPTION

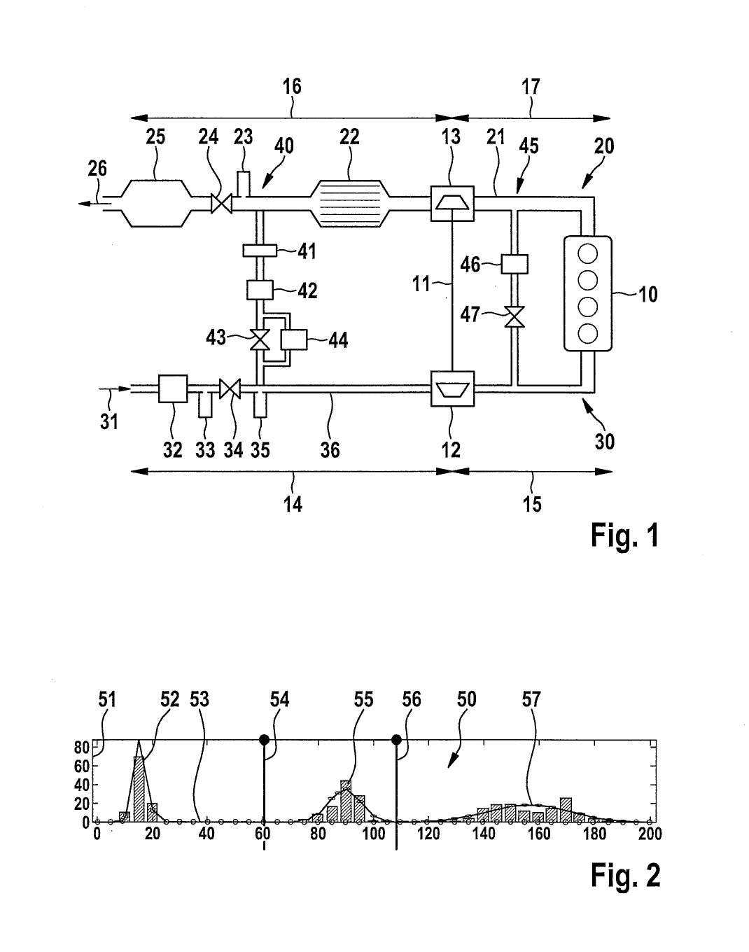

FIG. 1 shows a schematic illustration of an internal combustion engine 10 having an air supply duct 30 and an exhaust duct 20. The illustration is limited to the parts that are important for describing the present invention. Fresh air 31 is supplied along an air intake channel 36 of air supply duct 30 via a hot film air mass sensor 32, a fresh air throttle 34, and a compressor 12 of a turbocharger 11 of internal combustion engine 10. Air supply duct 30 is divided into an intake air low-pressure area 14 upstream from compressor 12 and an intake air high-pressure area 15 downstream from compressor 12 in the flow direction.

Exhaust gas 26 of internal combustion engine 10 is discharged from internal combustion engine 10 into the surroundings via exhaust duct 20 along an exhaust channel 21, via an exhaust gas turbine 13 of turbocharger 11, a particle filter 22, an exhaust flap 24, and a muffler 25. Exhaust duct 20 is divided into an exhaust gas high-pressure area 17 and an exhaust gas low-pressure area 16, exhaust gas low-pressure area 16 beginning downstream from exhaust gas turbine 13 in the flow direction.

A low-pressure exhaust gas recirculation line 40 connects exhaust gas low-pressure area 16 downstream from particle filter 22 to intake air low-pressure area 14 downstream from fresh air throttle 34. Low-pressure exhaust gas recirculation line 40 contains an exhaust gas filter 41, a first exhaust gas recirculation cooler 42, and a low-pressure exhaust gas recirculation valve 43 having a differential pressure sensor 44. The pressure of exhaust gas 26 upstream from exhaust flap 24 is determined with the aid of a first pressure sensor 23. The pressure of fresh air 31 is determined with the aid of a second pressure sensor 33 upstream from fresh air throttle 34 and with the aid of a third pressure sensor 35 downstream from fresh air throttle 34. In another specific embodiment, second and third pressure sensors 33, 35, respectively, may also be configured as differential pressure sensors.

A high-pressure exhaust gas recirculation line 45 connects exhaust gas high-pressure area 17 upstream from exhaust gas turbine 13 to intake air high-pressure area 15 downstream from compressor 12 via a second exhaust gas recirculation cooler 46 and a high-pressure exhaust gas recirculation valve 47.

During operation, the mass of fresh air 31 supplied to internal combustion engine 10 is determined by hot film air mass sensor 32. A subflow of exhaust gas 26 is added to fresh air 31 via low-pressure exhaust gas recirculation line 40. The resulting air mixture is compressed by compressor 12 of turbocharger 11 and supplied to internal combustion engine 10. Resulting exhaust gas 26 drives turbocharger 11 via exhaust gas turbine 13, and is expanded to a lower pressure level. Particle filter 22 subsequently filters particles from exhaust gas 26.

A portion of exhaust gas 26, which is controllable by low-pressure exhaust gas recirculation valve 43, is added to fresh air 31 via low-pressure exhaust gas recirculation line 40. A portion of exhaust gas 26, which is controllable by high-pressure exhaust gas recirculation valve 47, is added to fresh air 31 via high-pressure exhaust gas recirculation line 45. These measures are used to reduce the emissions of internal combustion engine 10. Exhaust gas filter 41 is used to retain any particles dislodged from particle filter 22, for example ceramic particles remaining from manufacture, in low-pressure exhaust gas recirculation line 40, and to protect downstream components such as compressor 12. In its function as an “emergency filter,” exhaust gas filter 41 is also used to retain particles in the event of damage of particle filter 22. If exhaust gas filter 41 is clogged, the mass flow through low-pressure exhaust gas recirculation line 40 may possibly be reduced so greatly that it is not possible to comply with regulations for allowable emissions of internal combustion engine 10. Under regulatory requirements, such as those of CARB, this condition must be recognized and reported as an error.

When the clogging in exhaust gas filter 41 is initially low, differential pressure sensor 44 determines a reduced mass flow and slightly opens low-pressure exhaust gas recirculation valve 43 via an associated control system of internal combustion engine 10. If this measure is no longer sufficient for heavier clogging of exhaust gas filter 41, the control system, depending on the overall system design, closes fresh air throttle 34 or exhaust flap 24, although they are expected to be open under the operating conditions. According to the exemplary embodiments and/or exemplary methods of the present invention, this is recognized as an error condition for a reduced mass flow in low-pressure exhaust gas recirculation line 40. The closing of fresh air throttle 34 may be determined via the position of a throttle valve of fresh air throttle 34, via the pressure difference between second pressure sensor 33 and third pressure sensor 35, or via the ratio of the pressures at second pressure sensor 33 and at third pressure sensor 35. The closing of exhaust flap 24 may be determined via the mechanical position of the exhaust flap, via the difference between the pressure at first pressure sensor 23 and the external pressure, or via the ratio of the pressure at first pressure sensor 23 to the external pressure.

FIG. 2 shows a pressure diagram 50 having a pressure axis 53 and a frequency axis 51. The frequency of occurrence of a certain differential pressure, removed [sic; plotted] on pressure axis 53, between the pressure at second pressure sensor 33 and the pressure at third pressure sensor 35 during operation of internal combustion engine 10 for different degrees of clogging of exhaust gas filter 41 from FIG. 1 is plotted on frequency axis 51. For a new exhaust gas filter 41, a first frequency distribution 52 of the pressure differences is determined. If the mass flow in low-pressure exhaust gas recirculation line 40, for example through an opening 10 mm in diameter, is reduced, a second frequency distribution 55 is determined. For a heavily clogged exhaust gas filter 41, a third frequency distribution 57 of the pressure differences is determined. If a first threshold value 54 is predefined, a reduced mass flow may be determined in the engine control system. If a higher second threshold value 56 is predefined, a greatly reduced mass flow may be determined, and an error may be displayed.

What is claimed is:

1. A method for monitoring errors in a low-pressure exhaust gas recirculation line of an internal combustion engine, the internal combustion engine being supplied with fresh air via an air supply duct with a compressor of a turbocharger, exhaust gas of the internal combustion engine being discharged via an exhaust duct with an exhaust gas turbine of the turbocharger, a subflow of the exhaust gas being supplied from an exhaust gas low-pressure area of the exhaust duct downstream from the exhaust gas turbine of the turbocharger, via the low-pressure exhaust gas recirculation line, to an intake air low-pressure area of the air supply duct upstream from the compressor of the turbocharger, the method comprising:
setting an exhaust gas mass flow of the subflow of the exhaust gas in the low-pressure exhaust gas recirculation line via a low-pressure exhaust gas recirculation valve, setting a fresh air mass flow being set by a fresh air throttle provided in the air supply duct, or an exhaust gas mass flow via an exhaust flap in the exhaust duct;
in operating points of the internal combustion engine in which the fresh air throttle or the exhaust flap is opened when the low-pressure exhaust gas recirculation line is free of errors, deducing an error in the low-pressure exhaust gas recirculation line if the fresh air throttle or the exhaust flap is at least partially closed.

2. The method of claim 1, wherein for assessing whether the fresh air throttle or the exhaust flap is at least partially closed, a pressure difference or a pressure ratio across the fresh air throttle or the exhaust flap, or a flap position of the fresh air throttle or of the exhaust flap, is evaluated.

3. The method of claim 1, wherein an error in the low-pressure exhaust gas recirculation line is deduced if a certain pressure difference in the flow direction in the air supply duct or of the exhaust duct, or a certain pressure ratio in the flow direction, is greater than a predetermined threshold value, or an error in the low-pressure exhaust gas recirculation line is deduced if a certain pressure difference opposite to the flow direction in the air supply duct or of the exhaust duct, or a certain pressure ratio opposite to the flow direction, is less than a predetermined threshold value, or if the flap position of the fresh air throttle or of the exhaust flap is further closed in the actuating direction than a predetermined threshold value.

4. The method of claim 3, wherein the threshold value is predefined as a function of the operating conditions of the internal combustion engine.

5. The method of claim 1, wherein the checking of the error condition begins only after the operating conditions of the internal combustion engine in which the fresh air throttle or the exhaust flap is opened have been present for at least at least one of a predefined enable time and the threshold value condition has been met for a predefined minimum period.

6. The method of claim 1, wherein an error condition for an insufficient or a restricted exhaust gas mass flow in the low-pressure exhaust gas recirculation line is deduced by comparison with various predefinable threshold values.

7. A device for monitoring errors in a low-pressure exhaust gas recirculation line of an internal combustion engine, an air supply duct having a compressor of a turbocharger for supplying fresh air to the internal combustion engine, an exhaust duct being provided with an exhaust gas turbine of the turbocharger for discharging exhaust gas of the internal combustion engine, the low-pressure exhaust gas recirculation line being provided downstream from the exhaust gas turbine of the turbocharger for withdrawing a subflow of the exhaust gas from an exhaust gas low-pressure area of the exhaust duct and for supplying the subflow of the exhaust gas to an intake air low-pressure area of the air supply duct upstream from the compressor of the turbocharger, a low-pressure exhaust gas recirculation valve being provided in the low-pressure exhaust gas recirculation line for setting an exhaust gas mass flow of the subflow of the exhaust gas, a fresh air throttle being provided in the air supply duct for setting a fresh air mass flow, or an exhaust flap being provided in the exhaust duct for setting an exhaust gas mass flow, comprising:
a control device, for monitoring errors, having a unit for generating an error display, wherein in operating points of the internal combustion engine in which the fresh air throttle or the exhaust flap is open when the low-pressure exhaust gas recirculation line is free of errors, the unit outputs the error display when the fresh air throttle or the exhaust flap is at least partially closed.

8. The device of claim 7, wherein there is an exhaust gas filter for removing particles from the subflow of the exhaust gas in the low-pressure exhaust gas recirculation line, and wherein the error monitoring is for displaying an impermissibly reduced subflow of the exhaust gas through the low-pressure exhaust gas recirculation line.
